(19) United States
(12) Patent Application Publication
(10) Pub. No.: US 2009/0006997 A1
(43) Pub. Date: Jan. 1, 2009

(54) WORKFLOW UI GENERATING METHOD AND GENERATOR

(76) Inventors: Le Yang Jiang, Beijing (CN); Yang Liu, Beijing (CN); Michael Starkey, Vancouver (CA); Jiang Bo Xue, Beijing (CN)

Correspondence Address: HOFFMAN WARNICK LLC, 75 STATE ST, 14 FL, ALBANY, NY, 12207, US

(21) Appl. No.: 12/145,739

(22) Filed: Jun. 25, 2008

(30) Foreign Application Priority Data
Jun. 28, 2007 (CN) 200710126838.5

(51) Int. Cl. G06F 3/048

(52) U.S. Cl. 715/771

(57) ABSTRACT

A workflow UI generating method and generator. A method according to an embodiment includes: creating and deploying a workflow UI definition file which comprises the mapping relationships between workflow data items, workflow participating roles, workflow activities, and workflow UI elements and their attributes; during the execution of the workflow: determining the workflow participating role to which the current user belongs; determining the current workflow activity of the workflow participating role; reading and parsing the workflow UI definition file, and obtaining workflow data items corresponding to the workflow participating role and its current workflow activity as well as corresponding workflow UI elements and their attribute according to the determined workflow participating role and its current workflow activity as well as the read and parsed mapping relationships; obtaining the values of the data items from a workflow engine; and generating and presenting to a user a workflow UI which comprises the workflow UI elements corresponding to the workflow data items and having the values of the data item and the attributes, and which can interact with the workflow engine through a workflow engine interface.

### CROSS-REFERENCE TO RELATED APPLICATIONS

This application claims the benefit of co-pending Chinese Patent Application No. 200710126838.5, filed 28 Jun. 2007, which is incorporated herein by reference.

### TECHNICAL FIELD

The present invention relates to the computer field, particularly to a workflow system, and more particularly to a workflow user interface (UI) generating method and generator.

### BACKGROUND ART

Since the concept of a workflow system was proposed in the 1970s, after tens of years of development, the workflow technology has become the basis of many internal and external business process systems of enterprises.

A workflow is a computation model of a work process, i.e., the appropriate model representation and the computation thereof in computers of the logic and rules that organize jobs in a work process together. The main problem to be solved by the workflow is: to transfer documents, information, or tasks automatically among a plurality of participants according a certain predetermined rule using computers in order to realize a certain business object.

The main function of a workflow management system (WFMS) is to define, execute and manage a workflow and coordinate the information exchange between jobs and team members during the execution of the workflow through the support of computer technology. The workflow needs to depend on the workflow management system to be realized.

In 1994, the Workflow Management Coalition (WFMC) published a workflow reference model for interoperation between workflow management systems, and drew a series of industrial standards successively. The workflow reference model defines the architectural model of a typical workflow management system, as shown in FIG. 1.

The workflow reference model identifies basic components constituting the workflow management system and interfaces used by these basic components to interact. These basic components include a workflow enactment service, workflow engine(s), workflow definition tools, client applications, invoked applications, and administration and monitoring tools. The interfaces used by the basic components to interact include interface 1, interface 2, interface 3, interface 4, and interface 5, wherein:

a) The workflow enactment service is a core component of a workflow management system, whose functions include creating and managing workflow definitions, creating, managing, and executing workflow instances. While the above functions are performed, an application program may interact with the workflow enactment service through a programming interface. A workflow enactment service may contain a plurality of workflow engines operating in a distributed manner. b) The workflow engine is a software component which provides a runtime environment to a workflow instance and interprets and executes the workflow instance.

c) The workflow definition tool is a tool for managing a workflow definition, and it can display graphically and operate a complex workflow definition. The workflow definition tool interacts with the workflow enactment service.

d) The client application is an application which interacts with the workflow enactment service via requests, i.e., the client application invokes the workflow enactment service.

e) The invoked application is an application invoked by the workflow enactment service. The invoked application interacts with the workflow enactment service to cooperate and complete the execution of an workflow instance.

f) The administration and monitoring tool is mainly used for the maintenance and management of such data as organizational units, roles, etc., and the monitoring of the workflow execution status. The administration and monitoring tool interacts with the workflow enactment service.

In a scenario, in order to implement a workflow in a workflow system, workflow developers may design a workflow template through the workflow definition tool. An administrator deploys the workflow template into the workflow system. UI developers design a UI for each workflow step according to the requirements of the workflow, and the administrator deploys the UIs into the workflow system. Thus, the user can initiate the workflow engine to create and execute a workflow instance based on the workflow template. When the workflow instance needs other roles or users to participate during its execution, the workflow enactment service will create corresponding workflow activities for them. When these users log on the workflow system, they will obtain these workflow activities through their respective UIs provided by client applications. Then, the users can work on these activities according to a standard-based workflow operation mode. When the activities have been completed, a workflow engine will continue to execute the workflow instance until the execution of the whole workflow instance is completed.

As an example, in order to implement a process for applying for reimbursement in a workflow system, the following steps may be needed:

a) Workflow developers design a workflow template for applying for reimbursement through the workflow definition tool;

b) An administrator deploys the workflow template for applying for reimbursement to the workflow system;

c) UI developers design and deploy a UI for each workflow step according to the requirements of the workflow for applying for reimbursement; and

d) End users participate in the workflow and complete their related workflow activities through the UIs generated in step c).

For example, for a process for applying for reimbursement containing 3 approval steps, the specific execution steps may be as follows:

1) An applicant for reimbursement inputs data for applying for reimbursement in a workflow initiating interface and initiates a workflow for applying for reimbursement;

2) The workflow engine creates and executes a workflow instance for applying for reimbursement;

3) The workflow engine creates a workflow activity for Manager of the applicant for reimbursement during its execution;

4) The manager logs on the workflow system to view and select this to-do activity;

5) The manager approves the application for reimbursement in an approval interface, and the background application logic will notify the workflow engine that the approval activity is completed;

6) The workflow engine continues the execution of the workflow instance, and creates a workflow activity for staff of the financial department;

7) The staff of the financial department logs on the workflow system, and obtains the to-do activity;

8) The staff of the financial department completes the to-do activity in a workflow UI, and the background will notify the workflow engine that the approval activity is completed; and

9) The workflow engine completes the execution of the whole workflow instance.

Taking WebSphere Integration Developer of IBM as an example, for a workflow activity, a user can perform the following standard processing operations:

a) claim: the user declares to begin to process a workflow activity. When a workflow activity belongs to a plurality of persons, only the user who first claims the activity can complete the activity. The IBM workflow engine provides the following methods to complete this operation:
public ClientObjectWrapper claim(java.lang.String aiid)
public ClientObjectWrapper claim(AIID aiid)

b) complete: after the claim, the user can complete the workflow activity. The workflow instance can be executed only after the workflow activity has been completed. The IBM workflow engine provides the following methods to complete the present operations:
public void complete(java.lang.String aiid)
public void complete(AIID aiid)
public void complete(AIID aiid, ClientObjectWrapper output)
public void complete(java.lang.String aiid, ClientObjectWrapper output)
public void complete(AIID aiid, ClientObjectWrapper faultMessage, java.lang.String faultName)
public void complete(java.lang.String aiid, ClientObjectWrapper faultMessage, java.lang.String faultName)

c) cancelClaim: the user can cancel the claim. The IBM workflow engine provides the following methods to complete this operation:
public void cancelClaim(java.lang.String aiid)
public void cancelClaim(AIID aiid)

d) forceRetry, forceComplete: when the workflow activity is stopped due to an execution error or other reasons, the administrator can force to retry or complete the activity. The IBM workflow engine provides the following methods to complete this operation:
public void forceRetry(java.lang.String aiid, boolean continueOnError)
public void forceRetry(AIID aiid, boolean continueOnError)
public void forceRetry(java.lang.String aiid, ClientObjectWrapper inputMessage, boolean continueOnError)
public void forceRetry(AIID aiid, ClientObjectWrapper inputMessage, boolean continueOnError)
public void forceComplete(java.lang.String aiid, boolean continueOnError)
public void forceComplete(AIID aiid, boolean continueOnError)
public void forceComplete(java.lang.String aiid, ClientObjectWrapper output, boolean continueOnError)
public void forceComplete(AIID aiid, ClientObjectWrapper output, boolean continueOnError)
public void forceComplete(java.lang.String aiid, ClientObjectWrapper message, java.lang.String faultName, boolean continueOnError)
public void forceComplete(AIID aiid, ClientObjectWrapper message, java.lang.String faultName, boolean continueOnError)

e) transfer: the user can transfer his own activity to another person to process. The IBM workflow engine provides the following methods to complete this operation:
public void transferWorkItem(AIID aiid, int assignmentReason, java.lang.String fromUserID, java.lang.String toUserID)
public void transferWorkItem(PIID piid, int assignmentReason, java.lang.String fromUserID, java.lang.String toUserID)
public void transferWorkItem(java.lang.String identifier, int assignmentReason, java.lang.String fromUserID, java.lang.String toUserID)

In addition, the following API can also be used to interact with the workflow engine to complete other related works:
Query all the workflows deployed in the system:
   public ProcessTemplateData[] queryProcessTemplates(java.lang.String whereClause, java.lang.String orderByClause, java.lang.Integer threshold, java.util.TimeZone timeZone)
Initiate a workflow:
   public PIID initiate(java.lang.String processTemplateName, ClientObjectWrapper inputMessage)
Query the workflow engine to obtain such information as to-do activities, etc.:
   public QueryResultSet queryAll(java.lang.String selectClause, java.lang.String whereClause, java.lang.String orderByClause, java.lang.Integer skipTuples, java.lang.Integer threshold, java.util.TimeZone timeZone)
   public QueryResultSet query(java.lang.String storedQueryName, java.lang.Integer skipTuples)
   public QueryResultSet query(java.lang.String selectClause, java.lang.String whereClause, java.lang.String orderByClause, java.lang.Integer skipTuples, java.lang.Integer threshold, java.util.TimeZone timeZone)
   public QueryResultSet query(java.lang.String selectClause, java.lang.String whereClause, java.lang.String orderByClause, java.lang.Integer threshold, java.util.TimeZone timeZone)
Obtain the status of a manual activity:
   public ActivityInstanceData getActivityInstance(AIID aiid)
Read/write workflow data from/to a workflow engine:
   public ClientObjectWrapper getVariable(PIID piid, java.lang.String variableName)
   public void setVariable(PIID piid, java.lang.String variableName, ClientObjectWrapper message)

It can be seen from the above description that in a typical workflow system, the workflow enactment service is responsible for the execution of a workflow in the background, and a client needs to participate in the execution of the workflow through a UI provided by the client application. At present, in order to access the functions of the workflow engine in a client application, a UI needs to be defined separately for each manual activity (i.e., a step in a work flow), and the UI program interacts with the workflow engine through a standard interface defined by the workflow engine.

In building today's enterprise business process applications, there is always a huge workload to generate UIs. For example, in a Websphere Process Server, we usually need to generate about 2 pages (jsp or portlet) for each workflow activity. For example, in a typical scenario, an enterprise has 20 workflows and each workflow has 10 human activities. Then developers must finish about 400 web pages. Also when the workflow data change, many pages need to be changed.

There are already some applications which can generate workflow UIs automatically, such as BPC Explorer shipped with WebSphere Process Server. FIGS. 2A and 2B show a schematic diagram of a method for generating a UI of an exemplary workflow using BPC Explorer, where FIG. 2A shows how to map the workflow definition to an interface definition and how to map the interface definition to a specific data schema definition in development environment; and FIG. 2B shows a screenshot of a UI for generating a workflow UI according to the above mappings in BPC Explorer. However, the following defects these applications have prevent them from being used in many real business scenarios: firstly, the existing workflow UI generators can not provide a separate UI definition mechanism, and they are more focused on the workflow data, instead of the UI presentation of these data. They only use the data schema defined by BPEL processes, which schema can hardly describe complex UI elements, such as text areas, radio buttons, calendar pickers, dropdown lists, etc. Secondly, they can't be customized according to different situations. For example, a manager and HR should view and access different data. Even the same manager should have different UIs at different workflow steps (for example, approval step and submitting step). Since there is no business-role-based UI definition and data filtering functions in such existing tools, if a user can access the workflow data, the manager can see all the contents, rather than that different UIs containing different data are provided according to different business roles and different steps. These tools do not have finer-granularity control over the workflow data, which control is required in many real application scenarios.

Obviously a new and more convenient, flexible and effective method and apparatus for generating workflow UIs is needed in the art.

### SUMMARY OF THE INVENTION

According to one aspect of the present invention, there is provided a method for generating a workflow UI, comprising: creating and deploying a workflow UI definition file which comprises the mapping relationships between workflow data items, workflow participating roles, workflow activities and workflow UI elements and their attributes; during the execution of the workflow: determining the workflow participating role to which the current user belongs and the current workflow activity of the workflow participating role; reading and parsing the workflow UI definition file, and obtaining the workflow data items corresponding to the workflow participating role and its current workflow activity as well as the corresponding workflow UI elements and their attributes according to the determined workflow participating role and its current workflow activity as well as the read and parsed mapping relationships; obtaining the values of the data items from a workflow engine; and generating and presenting to the user a workflow UI which comprises the workflow UI elements corresponding to the workflow data items and having the values of the data items and the attributes, and can interact with the workflow engine through a workflow engine interface.

According to anther aspect of the present invention, there is provided a workflow UI generator, comprising a role information collector for determining a workflow participating role to which the current user belongs; a workflow engine accessor for accessing a workflow engine to determine the current workflow activity of the workflow participating role; a workflow UI definition parser for reading and parsing a workflow UI definition file, which comprises the mapping relationships between workflow data items, workflow participating roles, workflow activities, and workflow UI elements and their attributes, and for obtaining the workflow data items corresponding to the workflow participating role and its current workflow activity as well as corresponding workflow UI elements and their attributes according to the determined workflow participating role and its current workflow activity as well as the read and parsed mapping relationships; wherein the workflow engine accessor is further used to obtain the values of the data items from the workflow engine; and a workflow UI presenter for generating and presenting to the user a workflow UI which comprises the workflow UI elements corresponding to the workflow data items and having the values of the data items and the attributes, and can interact with the workflow engine through a workflow engine interface.

According to a further aspect of the present invention, there is provided a workflow system comprising: one or more workflow UI definition files deployed in the workflow system for corresponding deployed workflows, the workflow UI definition files comprising the mapping relationships between workflow data items, workflow participating roles, workflow activities, and workflow UI elements and their attributes; and the above workflow UI generator.

According to a still further aspect of the present invention, there is provided a method for developing, deploying and maintaining a workflow UI, comprising: creating a workflow UI definition file which comprises the mapping relationships between workflow data items, workflow participating roles, workflow activities and workflow UI elements and their attributes; deploying the created workflow UI definition file into a workflow system so as to, during the execution of the workflow, generate a UI for a user's current activity from the workflow UI definition file according to interactions of the user with the workflow system; modifying the workflow UI definition file or creating a new workflow UI definition file as required; and deploying the modified or newly created workflow UI definition file into the workflow system so as to, during the execution of the workflow, generating a UI for the user's current activity from the modified or newly created workflow UI definition file according to interactions of the user with the workflow system.

The present invention can be further embodied in a computer readable medium which is used to store a computer program product comprising instructions for implementing the above method.

The workflow UI generating method and generator according to the present invention has numerous advantages, including, for example:

a) Simplify the work of developing UIs of a client application, and reduce UI developer's workload;

b) Can generate complex UIs automatically and dynamically;

c) Can be customized based on users' roles: users in different roles can have different UIs. Also, the same user role can access different workflow data in different workflow steps or can access workflow data in different ways;

d) Easy to learn and maintain: developers no longer need to learn and master a complex UI programming language and tools, and only need to compose a UI definition file in a text format such as Extensible Markup Language (XML), etc. which is easy to study and understand. In addition, when the workflow UI need to be changed later, it is only needed to change the UI definition file and redeploy the file.

### BRIEF DESCRIPTION OF THE DRAWINGS

The present invention can be better understood with reference to the following detailed description of an illustrative embodiment when read in conjunction with drawing.

FIG. 1 shows an architectural model of a typical workflow management system published by the Workflow Management Coalition.

FIGS. 2A and 2B show schematic diagrams of a method for generating a UI of an exemplary workflow by using BPC Explorer in the prior art.

FIG. 3 shows an exemplary employee promotion workflow and three UIs corresponding to three manual steps in the workflow respectively.

FIG. 4 shows the corresponding relationships between workflow data items, a workflow participating role, a workflow activity and workflow UI elements in the above exemplary workflow.

FIG. 5 shows a fragment of a workflow UI definition file composed with respect to the above exemplary workflow according to an embodiment of the present invention.

FIG. 6 shows a schematic diagram of a workflow UI generator and related workflow components according to an embodiment of the present invention.

FIG. 7 shows a method for developing, deploying and maintaining workflow UIs and a related workflow developing, deploying and running process according to an embodiment of the present invention.

FIG. 8 specifically shows a method for generating a workflow UI according to an embodiment of the present invention.

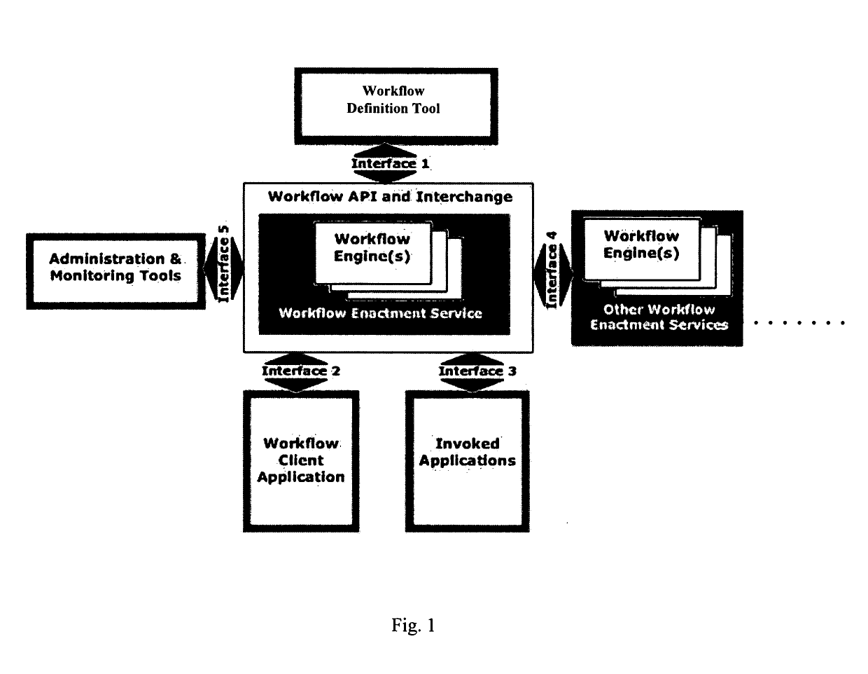

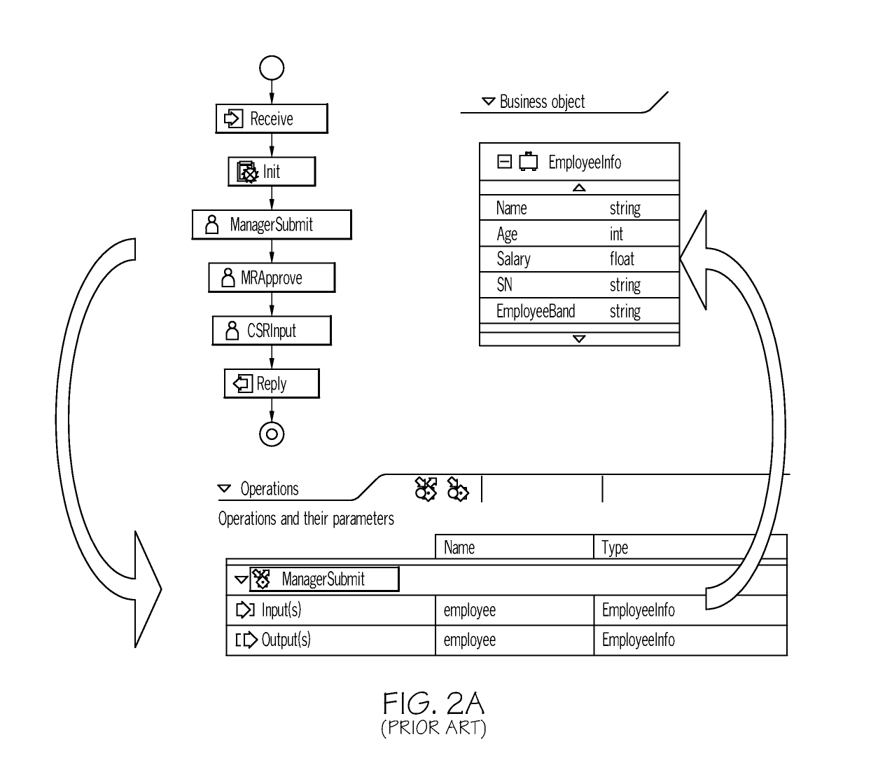

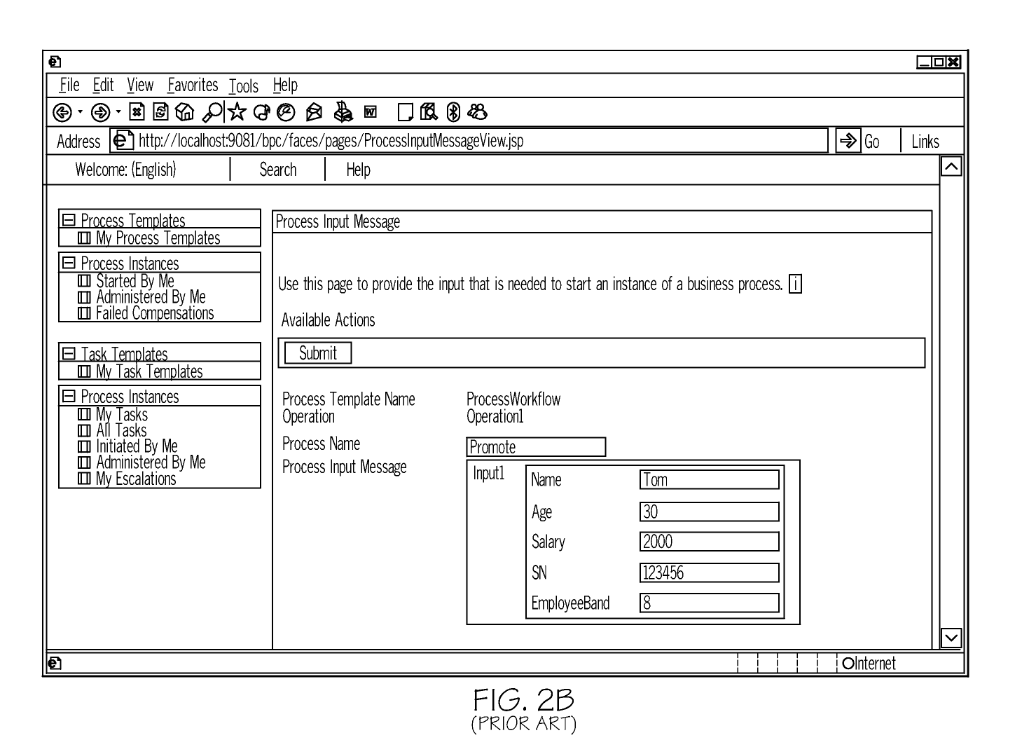

### DETAILED DESCRIPTION OF THE INVENTION

Embodiments of the present invention will be described below with respect to the drawings. However, it should be understood that the present invention is not limited to the described specific embodiments. On the contrary, it is construed that the present invention can be implemented and practiced using an arbitrary combination of the following features and elements, regardless of whether they relate to different embodiments. Therefore, the following aspects, features, embodiments and advantages are only illustrative, and should not be regarded as elements of or limitations to the attached claims, unless indicated explicitly in the claims. The reference to features, advantages or a similar language in the specification does not imply all or some features and advantages that can be realized using the present invention are within any single embodiment of the present invention. On the contrary, the language relating to features and advantages should be construed as only meaning that specific features, advantages and characteristics described in relation to the embodiments are contained in at least one embodiment of the present invention.

The present invention provides a dynamic, role-based, and workflow activity-centric UI generating method and generator. The present invention provides a workflow UI description standard or specification for setting each UI element, and business roles and workflow steps (activities) related thereto. The workflow UI generator of the present invention can generate a UI at runtime based on the workflow UI description, role information, and workflow interaction patterns. The generated UI can interact with a workflow engine through a standard or non-standard interface so as to implement the workflow.

First, the basic concept of the present invention will be described below with reference to a workflow example.

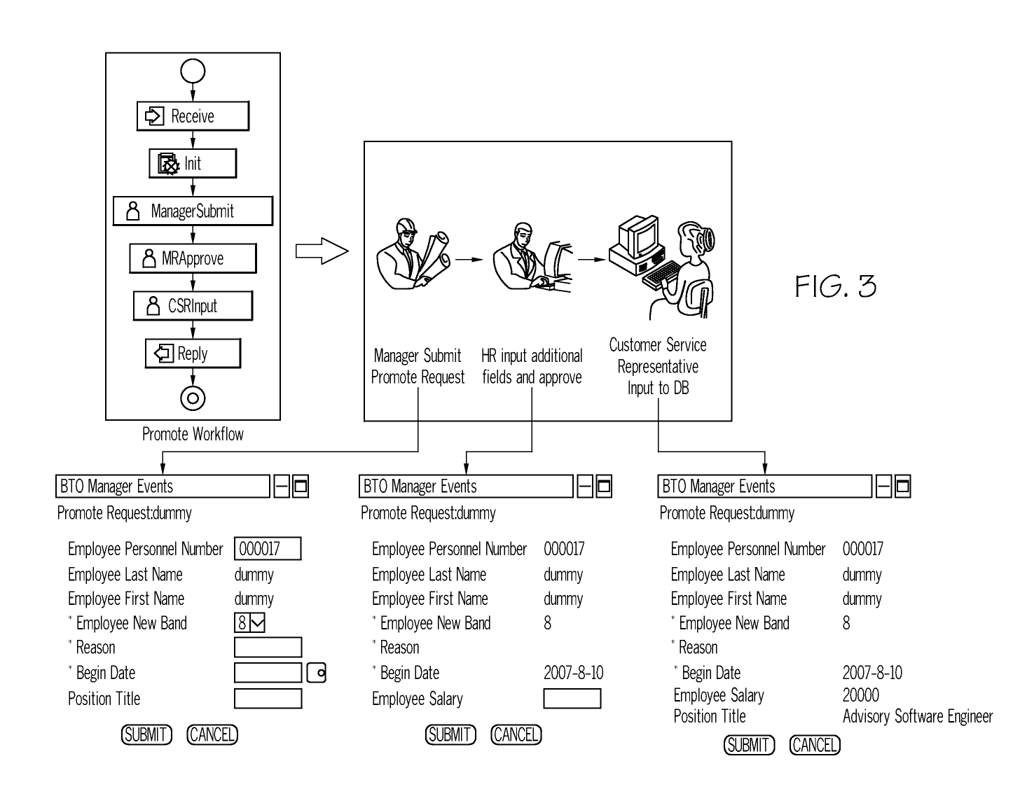

Consider an exemplary employee promotion workflow and 3 UIs corresponding to 3 manual steps in the workflow respectively, as shown in FIG. 3. This workflow includes the following 3 manual steps:

1) Manager submits a request to promote an employee;

2) HR (Human Resource) staff approves this request and determines the employee's new salary;

3) CSR (Customer Service Representative) then inputs all data into a DB.

In this example, different roles can only access different data of the employee, or can only access the data about the employee in different ways. Manager can change basic information about the employee, such as Employee Serial Number, Employee Last Name, Employee First Name, Employee New Band, Reason, Begin Date, and Position Title. Correspondingly, in the UI of Manager for submitting an employee promotion request, the UI elements for modifying the above information may include an editable or selectable textbox or dropdown list. HR can adjust the salary of the employee, but can not modify the other information of the employee. Correspondingly, in the UI of HR for adjusting the salary of the employee, an editable textbox of employee's salary is added, and other information of the employee is displayed as non-editable read-only label. Further, CSR can not change any data of the employee, but can view all the data. Therefore, in the UI of CSR, all the information of the employee is displayed as read-only labels.

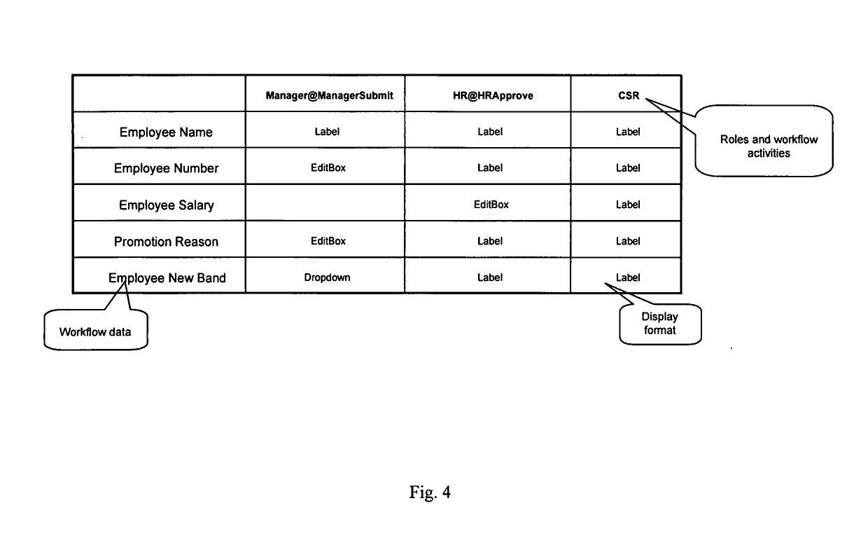

FIG. 4 shows the corresponding relationships between the workflow data items, workflow participating roles, workflow activities, and workflow UI elements in the above exemplary workflow. It can be seen from the table in FIG. 4 that the participating roles of the workflow and their activities comprise Manager@ManagerSubmit (i.e., Manager submits a request for employee promotion), HR@HRApprove (HR approves) and CSR (all activities of CSR role). The workflow data items comprise employee name, employee number, employee salary, promotion reason, and employee band. Herein, data items involved in the activity of Manager@ManagerSubmit are employee name, employee number, promotion reason, and employee band, and the display formats of these data items in the UI for this role and this activity, i.e., the UI elements corresponding thereto respectively, are label, textbox (editbox), textbox (editbox), and drop-down box. The data items involved in the activity of HR@HRApprove are employee name, employee number, employee salary, promotion reason, and employee band, and the display formats of these data items in the UI for this role and this activity, i.e., the UI elements corresponding thereto respectively, are label, label, textbox (editbox), label, and label. The data items involved with CSR are employee name, employee number, employee salary, promotion reason, and employee band, and the display formats of these data items in the UI for this role and this activity, i.e., the UI elements corresponding thereto respectively, are all labels.

In an embodiment of the present invention, based on the corresponding relationships between the workflow data items, workflow participating roles, workflow activities, and workflow UI elements in the workflow as shown in FIG. 4, a workflow UI definition file is composed, which has the following contents: which workflow data items can be accessed by which workflow participating roles in what workflow activities; and the display format of each data item. That is, the workflow UI definition file establishes the mapping relationships between the workflow data items, workflow participating roles, workflow activities, and workflow UI elements and attributes thereof.

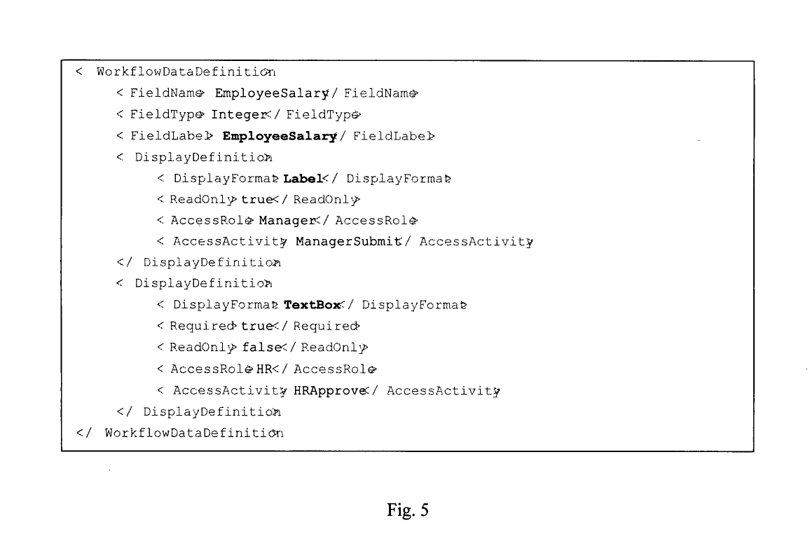

FIG. 5 shows a fragment of a workflow UI definition file composed with respect to the above exemplary workflow according to an embodiment of the present invention. As shown in FIG. 5, in the definition file is included a data item the name (<FieldName>), which is EmployeeSalary. The label (<FieldLabel>) of the data item in the UI is EmployeeSalary. Its display format (<DisplayFormat>) in a display definition (<DisplayDefinition>), i.e., a corresponding UI is a label, with its read-only attribute (<ReadOnly>) being true, its access role (<AccessRole>) Manager, and its access activity (<AccessActivity>) ManagerSubmit. The display format of the data item in another display definition is a textbox, with its required attribute (<Required>) being true, its read-only attribute false, its access role HR, and its access activity HRApprove. That is, the UI definition file fragment provides that the UI for the ManagerSubmit activity of the Manager role contains a read-only label corresponding to the data item of EmployeeSalary, while the UI for the HRApprove activity of the HR role contains a required editable textbox corresponding to the data item of EmployeeSalary. The structures of other portions of the workflow UI definition file are similar to the above fragment.

After the above workflow UI definition file has been composed, it will be deployed into a workflow system. Thereafter, during the running of the workflow, the workflow UI generator according to the present invention will load and parse the workflow UI definition file, so as to dynamically generate workflow UIs for different user roles and workflow activities. In an embodiment of the present invention, a single workflow UI definition file is defined and deployed for each workflow managed by a workflow system. Thus, when a user needs a workflow, a respective workflow UI definition file can be loaded, and a UI suitable for the role and current workflow activity of the user is generated.

It should be noted that the above described workflow UI definition method as well as the format of the workflow UI definition file and the elements and attributes therein, etc., are only an example of the workflow UI definition method and workflow UI definition file of the present invention, and not a limitation to it. In other embodiments of the present invention, a workflow UI definition file can be in a different format, such as other non-XML textual or non-textual formats, and can have other elements and attributes, etc. As long as the workflow UI definition file can express the mapping relationships between workflow data items, workflow participating roles, workflow activities, and workflow UI elements in a workflow, these variations are all within the scope of the present invention.

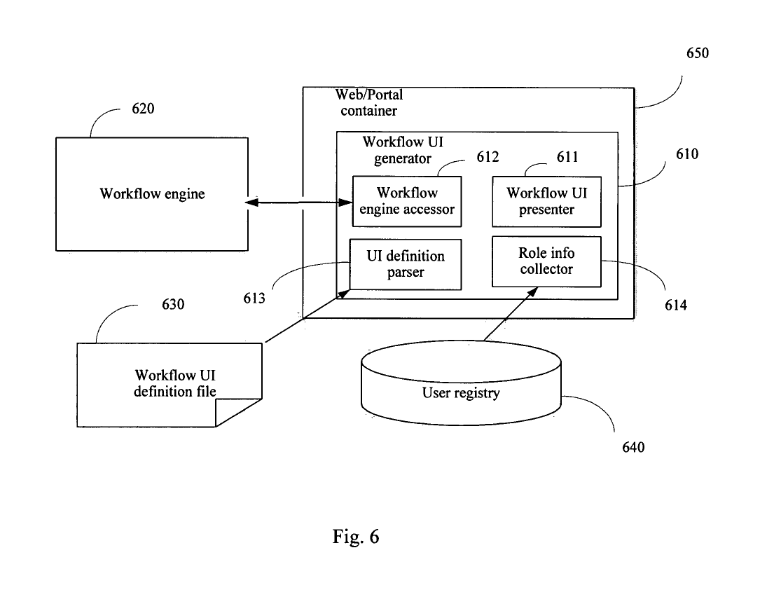

FIG. 6 shows a schematic diagram of a workflow UI generator and related workflow components according to an embodiment of the present invention.

As shown, according to an embodiment of the present invention, a workflow UI generator 610 runs in a Web container or Portal container 650. That is, according to the embodiment of the present invention, a Browser/Server architecture is adopted. Under such an architecture, the workflow UI generator 610 exists in the form of a Servlet/Portlet, and conforms to the Servlet/Portlet specification. It runs in an application server (such as WebSphere Application Server or WebSphere Portal Server), and is managed and served by the Web container or Portal container, which is a component in these application servers.

Thus, after a client sends a request, the request will first arrive at the application server (such as WebSphere Application Server or WebSphere Portal Server), then the Web container or Portal container of the application server will obtain the request, and then invoke the workflow UI generator according to the embodiment of the present invention to generate a UI. The generated UI code will be returned to the Web container (or Portal container), and then sent back by the application server to a browser of the client, so as to be displayed to the end user.

That is, the workflow UI generator 610 according to the present invention is implemented as a servlet or portlet, and can serve a client request directly. As an alternative, the workflow UI generator 610 can also exist as a standalone module. Thus, through the Web container or Portal container of the application server, the client request first arrives at another servlet or portlet, which in turn invokes the workflow UI generator 610 to generate UI code, which code is then sent back to the Web container/Portal container, and then further sent back to the client browser.

Of course, the workflow UI generator of the present invention can also be implemented using other techniques than a Servlet or Portlet, such as one of the other techniques that can generate dynamic web pages, for example, ASP, etc.

The workflow UI generator 610 can interact with a workflow engine 620 through workflow engine interfaces, and can access a workflow UI definition file 630 and a user registry 640. For example, in an embodiment of the present invention, when the user performs an operation on the generated UI, an operation request will be sent back to the workflow UI generator 610, which will further invoke a related workflow engine interface to interact with the workflow engine 620. Of course, it is also construed that, when the user performs an operation on the generated UI, the operation request will be sent back to another module than the workflow UI generator, which module is responsible for interacting with the workflow engine 620.

The workflow engine 620 is a container in which all business processes are running, and provides interfaces for reading workflow data, completing workflow activities and obtaining workflow activity status, etc. The workflow engine 620 can be any existing commercial or non-commercial workflow engine or a workflow engine to be developed in the future, such as a workflow engine in WebSphere Process Server of IBM.

The user registry 640 is a central repository for an enterprises to store its user, group, and organization information, in which are stored, for example, the mapping relationships between the ID of each user of the enterprise, the group and role to which the user belongs. Its form can be a file of any suitable format, relational or non-relational database, or LDAP directories, etc.

The workflow UI definition file 630 is a file containing defined workflow UI elements and stored in a file system according to an embodiment of the present invention. The file comprises the mapping relationships between workflow data items, workflow participating roles, workflow activities, workflow UI elements and attributes thereof. The file can be provided in XML format. Of course, any other text or non-text format is also possible.

The workflow UI generator 610 itself comprises the following 4 components:

1) A role information collector 614 for obtaining user, group and organization information from the user registry 640. For example, obtaining each workflow participating role to which the user belongs through the user ID of the user currently logging on. Such information is useful for screening out fields to be displayed on the workflow UI. The role information collector 614 can obtain the ID of the current user directly from the system context, and may also obtain the ID of the user currently logging on by, for example, invoking a method provided in the Web container or Portal container, and further query the user group and role to which the user belongs in the background user registry 640. If the information such as the user's role, etc., is stored in LDAP, the role information collector 614 can query through the standard LDAP query syntax. Further, if the information such as the user's role, etc., is stored in a DB, the role information collector 614 can query through the SQL language.

2) A workflow UI definition parser 613 for loading workflow UI definitions from a workflow UI definition file, and parsing it as data objects to facilitate further operations such as traversal, etc. Since the loaded and parsed workflow UI definition is included in the mapping relationships between the workflow data items, workflow participating roles, workflow activities, and workflow UI elements and attributes thereof, after the current workflow participating role and current workflow activity thereof having been determined, all the workflow data items related to the workflow participating role and the workflow activity and corresponding workflow UI elements and attributes thereof can be found by traversing all the parsed workflow UI definitions. When the workflow UI definition file is in XML format, the workflow UI definition parser 613 can be a standard XML parser.

3) A workflow engine accessor 612 for interacting with the workflow engine through a workflow engine API, including: querying a work list, obtaining current workflow activities and their statuses, reading workflow data and completing workflow activities, etc. For example, when a user has selected or initiated a workflow and the workflow participating role to which the user belongs has been obtained by the role information collector 614, the workflow engine accessor 612 can access the workflow engine 620 to obtain the current workflow activity of the workflow participating role and the status thereof. In addition, after all the workflow data items related to the current workflow participating role and the current workflow activity have been obtained through the workflow UI definitions loaded and parsed by the workflow UI definition parser 613, the workflow engine accessor 612 can access the workflow engine 620 to obtain the values of all these workflow data items so as to display them in a workflow UI. After the workflow UI generator 610 has generated a workflow UI and provides it to the user, when the user perform an operation on the workflow UI, a user request corresponding to the operation can be sent to the workflow engine accessor 612 in the workflow UI generator 610, enabling the workflow engine accessor 612 to access the workflow engine 620, so as to complete the workflow activity.

4) A workflow UI presenter 611 for generating a workflow UI based on all the workflow data items and their values related to the current workflow participating role and workflow activity, as well as corresponding workflow UI elements and their attributes, wherein the workflow UI comprises the workflow UI elements corresponding to the workflow data items and having the attributes and the values of the data items. The workflow UI presenter 611 is further used for generating corresponding operation buttons in the workflow UI according to the status of the current activity. For example, when the user has not claimed the activity, a Claim button can be generated in the workflow UI. And when the status of the activity is claimed, a CancelClaim button and a Complete button can be generated in the workflow UI, etc.

In an embodiment of the present invention, the generated UI can run in a Web container or Portal container, and can interact with the workflow engine through workflow engine interfaces, thus the user can complete the workflow activity through the workflow UI. Specifically, when the user completes editing operations in the generated workflow UI, the user can click a button such as Complete in the UI to submit. The submitted request can be transferred to the workflow UI generator through the Web container or Portal container, and the workflow UI generator can (for example, through a workflow engine accessor therein) execute a related interface function and interact with the workflow engine, so as to complete the workflow activity. Alternatively, the submitted request can also be transferred through the Web container or Portal container to a separate servlet or portlet, which can execute a related interface function to interact with a workflow engine, so as to complete the workflow activity.

The generated UI can be either HTML code which can be accessed by a browser, or other code such as WML code that can be accessed by a mobile device such as a mobile phone, etc.

In an embodiment of the present invention, the workflow definition standard used is BPEL (Business Process Execution Language), and WebSphere Integration Developer of IBM is used to develop a workflow, and deploy it onto the IBM WebSphere Process Server for execution. Further, the workflow UI generator and generated workflow UI of the present invention use interfaces defined by BPEL itself to interact with the workflow engine, thus completing the creation of workflow UIs and various activities during the running of the workflow.

It should be noted that, the workflow UI generator according to an embodiment of the present invention as shown in FIG. 6 and described above is only exemplary and illustrative, and not a limitation to the present invention. The workflow UI generator of the present invention can have more, less or different components, and the functions of the various modules can be performed by other modules. For example, the workflow UI generator 610 of the present invention can further have a control module for coordinating operations among the various modules, or the function for coordinating operations among the various modules can be performed by one of the modules such as the workflow UI presenter 611. For another example, the function of finding all the workflow data items related to the current workflow participating role and workflow activity and the corresponding workflow UI elements and attributes thereof by traversing all the parsed workflow UI definitions can be performed either by the workflow UI definition parser 613, or by the workflow UI presenter 611, or by a separate module.

The workflow UI generator 610, workflow UI definition file 630, user registry 640 and workflow engine 620 can be located in a computer network environment, and can be located in a server computer in the computer network, which server computer is connected to a plurality of client computers through a network. Users of the workflow system interact with the workflow system on the server computer and the workflow UI generator according to the present invention through their respective client computers. The workflow UI generator 610, workflow UI definition file 630, user registry 640, and workflow engine 620 can also be located in different computers in the network, and connect and communicate with each other through the network. Further, the modules in the workflow UI generator 610 can be located on the same computer or different computers.

In addition, although FIG. 6 only shows the workflow engine 620, etc., related to the workflow UI generator according to an embodiment of the present invention, a person skilled in the art may contemplate that other components that are not shown can exist in the workflow system and the computer network system in which the workflow system runs.

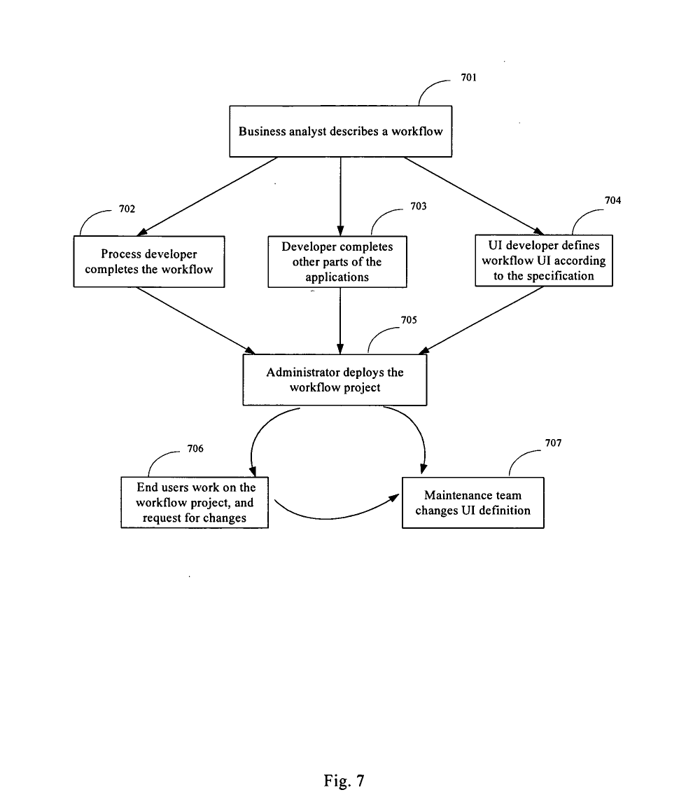

FIG. 7 shows a method for developing, deploying, and maintaining workflow UIs and related workflow developing, deploying and running process according to an embodiment of the present invention.

As shown, at step 701, a business analyzer analyzes a business process, and forms a workflow description.

At step 702, a process developer completes the development of a workflow system according to the workflow description, including the design and development of workflow templates, etc.

At step 703, the developer completes other parts of the workflow application, for example, developing other application supporting the workflow application, creating a database needed by the workflow application.

At step 704, a UI developer composes a workflow UI definition file according to the workflow UI definition specification of the present invention, the workflow UI definition file containing the mapping relationships between the workflow data items, the workflow participating roles, the workflow activities and the workflow UI elements and attributes thereof in the workflow.

At step 705, an administrator deploys the workflow project, including deploying a workflow template and other supporting program, and deploying the workflow UI definition file into the workflow system.

At step 706, an end user can work on the workflow project, i.e., generate and run a workflow instance. During the running of the workflow, a UI for the user's current activity will be generated from the workflow UI definition file according to interactions between the user and the workflow system. In addition, during the running of the workflow, according to business needs, the user may need to change the workflow, for example changing a certain UI of the workflow, etc.

In such a case, at step 707, a maintenance team or a UI developer only needs to modify or recompose a workflow UI definition file and returns to step 705 to redeploy the modified or recomposed UI definition file into the workflow system, so that during the running of the workflow, a new UI for the user's current activity can be generated from the modified or newly created workflow UI definition file according to interactions between the user and the workflow system.

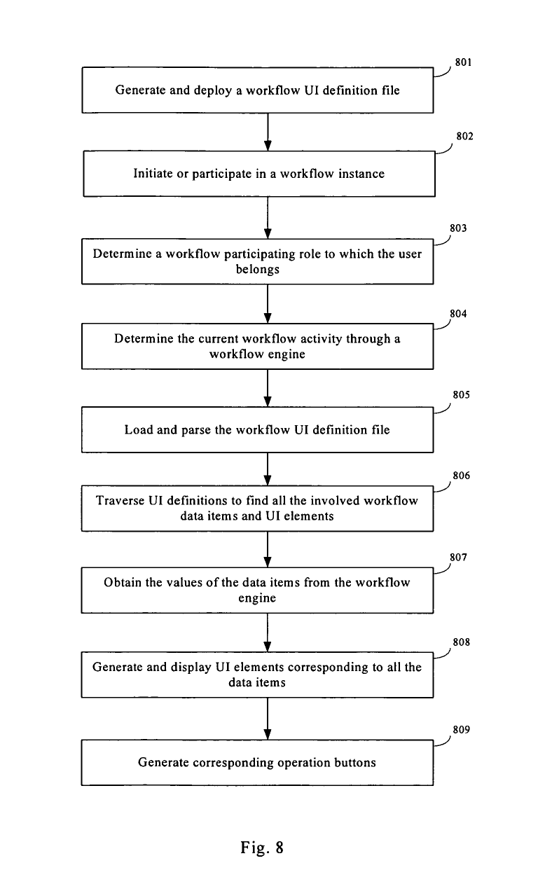

A method for generating a workflow UI according to an embodiment of the present invention will be described specifically below with reference to FIG. 8. In the following, the method for generating a workflow UI according to an embodiment of the present invention is described as being carried out by the above UI generator 610 according to an embodiment of the present invention, however, this is only illustrative and exemplary, and not a limitation to the present invention. On the contrary, the method for generating a workflow UI according to an embodiment of the present invention can also be carried out by other apparatuses.

As shown in FIG. 8, at step 801, there is generated and deployed a workflow UI definition file which comprises the mapping relationships between workflow data items, workflow participating roles, workflow activities, and workflow UI elements and attributes thereof. In an embodiment of the present invention, the workflow UI definition file is in XML format. Of course, the workflow UI definition file can also adopt any other format that can express the mapping relationships between workflow data items, workflow participating roles, workflow activities, and workflow UI elements and attributes thereof. Any XML editing tool or text editing tool can be used to generate the workflow UI definition file which will be deployed into a workflow system. In an embodiment of the present invention, a workflow UI definition file can be generated and deployed for each workflow, and a plurality of workflow UI definition files corresponding to a plurality of workflows can be deployed in the workflow system.

At step 802, after logging on the workflow system, a user can initiate and create a workflow instance, or participate in a running workflow instance. A list listing all the workflows and running workflow instances managed by the workflow system can be provided in an initial UI after the user logs on the workflow system, for the user to select therefrom to create a workflow instance or participate in a running workflow instance. For example, the workflow UI generator 610 according to an embodiment of the present invention can invoke the query interface function in WebSphere Process Server to obtain the workflow instances that the current user can participate in; and the workflow UI generator 610 according to an embodiment of the present invention can invoke the initiate function in WebSphere Process Server to initiate and create a workflow instance to be managed by WebSphere Process Server.

At step 803, after the workflow UI generator 610 according to an embodiment of the present invention receives a request for creating or participating in a workflow instance from a client through a Web container or Portal container, the role information collector 614 therein can obtain the ID of the current user directly from the system context, or the role information collector 614 can obtain the ID of the user currently logging on, for example, by invoking a method provided in the Web container or Portal container, and query the user group and role to which the user belongs in the background user registry 640 according to the ID.

At step 804, the workflow UI generator 610 according to an embodiment of the present invention can access the workflow engine 620 through the workflow engine accessor 612 therein to determine the current workflow activity of the workflow participating role. For example, it can obtain such information as the current activity of the role to which the current user belongs and the status of the current activity through a standard workflow engine interface such as the query and getActivityInstance, etc., based on the workflow instance name obtained at step 802. When the user initiates and creates a workflow, the name of the workflow selected by the user can be directly obtained from the user request from the client and the current activity is determined as the initial activity.

At step 805, the workflow UI definition parser 613 in the workflow UI generator 610 according to an embodiment of the present invention can, based on the workflow name, find a corresponding workflow UI definition file, load the workflow UI definition file, and parse the file with, for example, a standard XML parser, so as to convert the content in the UI definition file into object representations in the memory.

At step 806, the workflow UI presenter 611 or workflow UI definition parser 613 or another component in the workflow UI generator 610 according to an embodiment of the present invention can traverse in the UI definitions loaded and parsed at step 805 according to the user role information obtained at step 803, the current workflow activity obtained at step 804 and other information, to find all the UI elements and attributes thereof involved and the corresponding workflow data items.

At step 807, for all the workflow data items obtained at step 806, the workflow engine accessor 612 in the workflow UI generator 610 according to an embodiment of the present invention can obtain the corresponding data values from a workflow engine through, for example, a standard workflow engine interface getVariable( ).

At step 808, for all the workflow data items obtained at step 806, the workflow UI presenter 611 can, according to the defined display format (i.e., the corresponding UI elements and attributes thereof obtained at step 806), generate the corresponding UI elements one by one in the defined order, and display them on the UI of the end user.

At step 809, the workflow UI presenter 611 can, according to the status of the current activity obtained at step 804, generate corresponding operation buttons such as Claim, CancelClaim, Complete, and Transfer, etc. on the UI according to, for example, a standard activity processing mode of the workflow.

The UI containing the UI elements and necessary operation buttons as generated in steps 808 and 809 will be provided to the user, such as displayed on the browser of the user. According to an embodiment of the present invention, when the user clicks on one of these buttons, a corresponding user request will be sent from the browser to an application server, and be transferred to the workflow UI generator 610 according to an embodiment of the present invention through a Web container or Portal container in the application server, and the workflow engine accessor 612 in the workflow UI generator 610 will invoke a corresponding workflow engine interface function so as to make the workflow engine execute a corresponding workflow operation. For example, in an embodiment of the present invention, when the user clicks on a Claim button on the UI, the invocation of a claim function will be triggered; when the user clicks a CancelClaim button on the UI, the invocation of a cancelClaim function will be triggered; and when the user clicks on a Complete button on the UI, the invocation of a complete function will be triggered, and so on.

While the method for generating a workflow UI according to an embodiment of the present invention has been described above, it should be noted that the above description is only an example, and not a limitation to the present invention. The method for generating a workflow UI of the present invention can have more, less or different steps, some steps can be executed in different order or in parallel, some steps can be divided into more steps or be combined into less steps, and so on. For example, the method for generating a workflow UI of the present invention can further comprise a step for generating and deploying a workflow template. For another example, the step 805 of reading and parsing the workflow UI definition file can also be executed before the step 803 of determining the workflow participating role to which the current user belongs and the step 804 of determining the current workflow activity of the user, or in parallel with them. For a further example, the step 805 of reading and parsing the workflow UI definition file can also be combined with the step 806 of traversing the read and parsed workflow UI definitions to find all the involved UI elements and corresponding workflow data items, to form a single step. In addition, the step 808 of generating UI elements can also be combined with the step 809 of generating operation buttons on the UI into a single step of generating a workflow UI, and so on. All these variations are within the spirit and scope of the present invention.

The present invention can be implemented in the form of hardware, software or a combination thereof. The present invention can be implemented in a centralized manner in one computer system, or a distributed manner in which different components are distributed in a plurality of interconnected computer systems. Any computer system or other devices suitable for carrying out the method described herein is suited. A typical combination of hardware and software can be a general purpose computer system having a computer program, which when being loaded and executed, controls the computer system and causes it to carry out the method described in the present specification.

The present invention can be embodied in a computer program product, which comprises all the features enabling the implementation of the methods described herein, and when being loaded into a computer system, can carry out these methods.

While the present invention has been shown and described above specifically with reference to the preferred embodiments, a person skilled in the art will understand that various changes can be made in form and detail without departing from the spirit and scope of the present invention.

1. A method for generating a workflow user interface (UI), comprising:
creating and deploying a workflow UI definition file which comprises mapping relationships between workflow data items, workflow participating roles, workflow activities, and workflow UI elements and their attributes;
during an execution of the workflow:
determining a workflow participating role to which a current user belongs;
determining a current workflow activity of the workflow participating role;
reading and parsing the workflow UI definition file, and obtaining: the workflow data items corresponding to the workflow participating role and its current workflow activity; the corresponding workflow UI elements and their attributes according to the determined workflow participating role and its current workflow activity; and the read and parsed mapping relationships;
obtaining values of the data items from a workflow engine; and
generating and presenting to the user a workflow UI which comprises the workflow UI elements corresponding to the workflow data items and having the values of the data items and the attributes, and which can interact with the workflow engine through a workflow engine interface.

2. The method according to claim 1, wherein determining the current workflow activity of the workflow participating role further comprises:
determining a status of the current workflow activity of the workflow participating role through the workflow engine, and wherein the workflow UI generated and presented to the user further comprises operation buttons corresponding to the status of the current workflow activity, wherein the user interacts with the workflow engine by operating the operation buttons.

3. The method according to claim 1, wherein the workflow UI definition file is in Extensible Markup Language (XML) format.

4. The method according to claim 1, wherein generating and presenting to the user a workflow UI is performed through a Web container or Portal container, and the workflow UI interacts with the workflow engine through the Web container or Portal container.

5. The method according to claim 1, wherein the workflow engine interface is a Business Process Execution Language (BPEL) interface.

6. A workflow user interface (UI) generator, comprising
a role information collector for determining a workflow participating role to which a current user belongs;
a workflow engine accessor for accessing a workflow engine to determine a current workflow activity of the workflow participating role;
a workflow UI definition parser for reading and parsing a workflow UI definition file, which comprises mapping relationships between workflow data items, workflow participating roles, workflow activities, and workflow UI elements and their attributes, and for obtaining workflow data items corresponding to the workflow participating role and its current workflow activity as well as corresponding workflow UI elements and their attributes according to the determined workflow participating role and its current workflow activity as well as the read and parsed mapping relationships;
wherein the workflow engine accessor is further used to obtain values of the data items from the workflow engine; and
a workflow UI presenter for generating and presenting to the user a workflow UI which comprises the workflow UI elements corresponding to the workflow data items and having the values of the data items and the attributes, and which can interact with the workflow engine through a workflow engine interface.

7. The workflow UI generator according to claim 6, wherein the workflow engine accessor is further used to determine a status of the current workflow activity of the workflow participating role, and the workflow UI generated and presented to the user further comprises operation buttons corresponding to the status of the current workflow activity, wherein the user interacts with the workflow engine by operating the operation buttons.

8. The workflow UI generator according to claim 6, wherein the workflow UI definition file is in Extensible Markup Language (XML) format.

9. The workflow UI generator according to claim 6, wherein the workflow UI generator runs in a Web container or Portal container, and the workflow UI interacts with the workflow engine through the Web container or Portal container.

10. The workflow UI generator according to claim 6, wherein the workflow engine interface is a Business Process Execution Language (BPEL) interface.

11. A workflow system comprising:
a workflow engine;
at least one workflow UI definition file deployed in the workflow system for corresponding deployed workflows, the workflow UI definition files containing the mapping relationships between workflow data items, workflow participating roles, workflow activities, and workflow UI elements and their attributes; and
a workflow user interface (UI) generator, comprising:
a role information collector for determining a workflow participating role to which a current user belongs;
a workflow engine accessor for accessing a workflow engine to determine a current workflow activity of the workflow participating role;
a workflow UI definition parser for reading and parsing a workflow UI definition file, which comprises mapping relationships between workflow data items, workflow participating roles, workflow activities, and workflow UI elements and their attributes, and for obtaining workflow data items corresponding to the workflow participating role and its current workflow activity as well as corresponding workflow UI elements and their attributes according to the determined workflow participating role and its current workflow activity as well as the read and parsed mapping relationships;
wherein the workflow engine accessor is further used to obtain values of the data items from the workflow engine; and
a workflow UI presenter for generating and presenting to the user a workflow UI which comprises the workflow UI elements corresponding to the workflow data items and having the values of the data items and the attributes, and which can interact with the workflow engine through a workflow engine interface.

12. A method for developing, deploying and maintaining workflow UIs, comprising:
creating a workflow user interface (UI) definition file which comprises mapping relationships between workflow data items, workflow participating roles, workflow activities and workflow UI elements and their attributes;
deploying the created workflow UI definition file into a workflow system so as to, during an execution of the workflow, generate a UI for a current activity of a user from the workflow UI definition file according to interactions of the user with the workflow system;
modifying the workflow UI definition file or creating a new workflow UI definition file as required; and
deploying the modified or newly created workflow UI definition file into the workflow system so as to, during the execution of the workflow, generate a UI for the current activity of the user from the modified or newly created workflow UI definition file according to interactions of the user with the workflow system.
